(19) United States
(12) Patent Application Publication
(10) Pub. No.: US 2004/0083488 A1
(43) Pub. Date: Apr. 29, 2004

(54) Receiving apparatus, data communication system, and method for data communication

(76) Inventors: Shuichi Fukuda, Tokyo (JP); Manabu Ishii, Tokyo (JP)

Correspondence Address: BIRCH STEWART KOLASCH & BIRCH, PO BOX 747, FALLS CHURCH, VA, 22040-0747, US

(21) Appl. No.: 10/331,990

(22) Filed: Dec. 31, 2002

(30) Foreign Application Priority Data
Oct. 23, 2002 (JP) 2002-308967

(51) Int. Cl. H04N 7/173; H04N 5/44; H04N 5/50; G06F 13/00; H04N 5/445; G06F 3/00

(52) U.S. Cl. 725/38; 725/118; 725/131; 348/734; 348/731; 725/37

(57) ABSTRACT

A data communication system capable of supplying information most desired by the receiving side in accordance with the state of a channel, wherein the receiving side transmits setting information for information transmission to the transmitting side, and the transmitting side generates and transmits the content data according to the setting information from the receiving side, a receiving apparatus of such a data communication system, and a data communication method for the same. The receiving apparatus reproduces the picture and sound signals according to received picture packets and sound packets, displays the reproduced picture as well as the state of the channel and the operational commands for the setting information, receives operational commands from the user by event processing, changes the setting information accordingly, then transmits the changed setting information to the transmitting apparatus. The transmitting apparatus generates the picture and the sound packets in accordance with the parameters acquired from the setting information and transmits them to the receiving apparatus. Therefore, it is able to transmit the information desired by the user to the receiving apparatus in accordance with the state of the channel.

### BACKGROUND OF THE INVENTION

1. Field of the Invention

The present invention relates to a receiving apparatus utilized in a data communication system, for example, a data communication system transmitting picture and sound signals between a transmitter and a receiver through a data communication network, such a data communication system, and a data communication method thereof.

2. Description of the Related Art

In a picture and sound communication system of the related art, for example, in a television conference system that interactively transmits pictures and sound through a communication network, the amount of the information being transmitted is determined overall by the transmitting side. The receiving side just receives the transmitted picture and sound signals and is unable to suitably control the quality of the pictures and sound in accordance with the condition of the channel.

In a communication system, the party requiring the information is essentially the receiver. In the data communication system of the related art described above, however, the amount of information and the quality of the information required by the receiver, for example, the picture signals and sound signals, cannot be designated by the receiver and are all determined by the transmitter. Further, in a communication environment where the state of the channel changes constantly and the bandwidth is restricted, the transmitter is not able to obtain information as to whether the receiver has received the necessary information or not. As a result, there was a chance that data communication could not be achieved smoothly.

In addition, in a data communication system of the related art, once a communication disturbance occurs and the connection is broken, it is difficult to restore the normal state.

### SUMMARY OF THE INVENTION

An object of the present invention is to provide a receiving apparatus in a data communication system capable of providing the most desired information to a receiver in accordance with the state of the channel by transmitting setting information for data transmission from the receiver to the transmitter and transmitting content data by the transmitter according to the setting information transmitted by the receiver, such a data communication system, and a data communication method thereof.

To obtain the above object, according to a first aspect of the present invention, there is provided a receiving apparatus comprising a reception unit for receiving content data transmitted through a communication network; a signal reproduction unit for generating at least one of a picture signal and sound signal in accordance with the content data received by the reception unit; a channel state judgment unit for judging the state of the channel through which the content data is transmitted in accordance with the received content data; and a setting information generation unit for generating setting information and transmitting it to a transmitting apparatus, wherein the setting information includes parameters for generating the content data in accordance with the result of the judgment by the channel state judgment unit and commands input from outside based on the result of the judgment.

According to a second aspect of the present invention, there is provided a data communication system for transmitting at least one of picture data and sound data through a communication network, comprising a transmitting apparatus including a data generation unit for encoding at least one of a picture signal and sound signal and generating at least one of picture data and sound data in accordance with setting information and a setting information reception unit for receiving setting information transmitted from a receiving apparatus through the communication network and providing the setting information to the data generation unit and a receiving apparatus including a reception unit for receiving at least one of the picture data and the sound data transmitted from the transmitting apparatus through the communication network and a setting information generation unit for judging the transmitting state of the communication network in accordance with the received data by the reception unit, generating the setting information including parameters for generating at least one of the picture data and the sound data in the data generation unit of the transmitting apparatus according to the judgment result, and transmitting the setting information to the transmitting apparatus through the communication network.

According to a third aspect of the present invention, there is provided a data communication method for transmitting picture data and sound data through a communication network, comprising having a transmitting apparatus receive setting information transmitted from a receiving apparatus through the communication network and encode at least one of a picture signal and sound signal in accordance with the setting information and generate at least one of picture data and sound data and having a receiving apparatus receive at least one of the picture data and sound data transmitted from the transmitting apparatus and judge the transmission state of the communication network in accordance with the received data, generate setting information including parameters for generating at least one of the picture data and sound data in the transmitting apparatus according to the judgment result, and transmit the setting information to the transmitting apparatus through the communication network.

### BRIEF DESCRIPTION OF THE DRAWINGS

The above and other objects and features of the present invention will become more apparent with reference to the accompanying drawings, in which:

FIG. 1 is a block diagram of a data communication system according to an embodiment of the present invention;

FIG. 2 is a view of the content of a picture packet transmitted in the data communication system of the present invention;

FIG. 3 is a view of the content of a sound packet transmitted in the data communication system of the present invention;

FIG. 4 is a view of the content of a setting information packet transmitted in the data communication system of the present invention;

FIG. 5 is a flow chart of the time processing in a transmitting apparatus of the present invention;

FIG. 6 is a flow chart of the picture processing in the transmitting apparatus of the present invention;

FIG. 7 is a flow chart of the sound processing in the transmitting apparatus of the present invention;

FIG. 8 is a flow chart of the setting information reception processing in the transmitting apparatus of the present invention;

FIG. 9 is a flow chart of the time processing in a receiving apparatus of the present invention;

FIG. 10 is a flow chart of the reception processing in the receiving apparatus of the present invention;

FIG. 11 is a flow chart of a subroutine of picture packet processing in the receiving apparatus of the present invention;

FIG. 12 is a flow chart of a subroutine of sound packet processing in the receiving apparatus of the present invention;

FIG. 13 is a flow chart of a subroutine of event processing in the receiving apparatus of the present invention; and

FIG. 14 is a view of a screen display of a receiving apparatus of the present invention.

### DESCRIPTION OF THE PREFERRED EMBODIMENTS

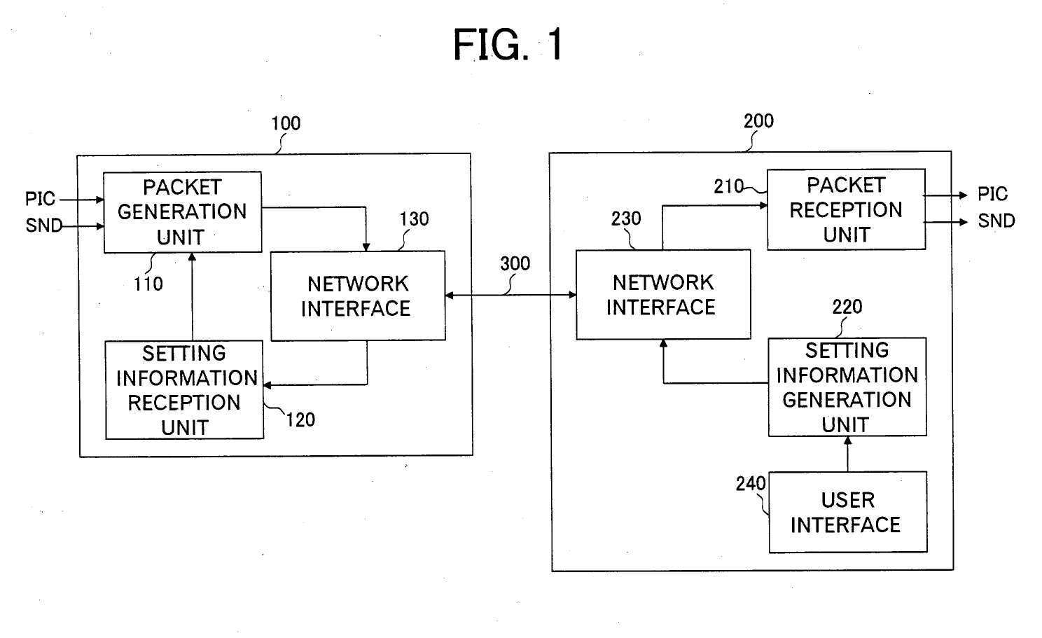

FIG. 1 is a view of the configuration of a data communication system according to an embodiment of the present invention.

As illustrated, the data communication system of the present invention is constituted by a transmitting apparatus 100, a receiving apparatus 200, and a channel 300.

The transmitting apparatus 100 includes a packet generation unit 110, a setting information reception unit 120, and a network interface 130.

The receiving apparatus 200 includes a packet reception unit 210, a setting information generation unit 220, a network interface 230, and a user interface 240.

The channel 300 is formed by a communication network for transmitting information, for example, the Internet, or a wireless communication network. In the channel 300, the traffic changes largely in accordance with the state of use of users. Accordingly, the available bandwidth between the transmitting apparatus 100 and the receiving apparatus 200 changes constantly. As a result, the amount of the information that can be transmitted from the transmitting apparatus 100 to the receiving apparatus 200 in a unit time changes, too.

In the transmitting apparatus 100, the packet generation unit 110 encodes a picture signal PIC and sound signal SND to be transmitted to the reception unit 200, compresses the encoded data according to necessity, generates the picture packets and the sound packets, then transmits the packets to the receiving apparatus 200 through the network interface 130 and the channel 300.

The setting information reception unit 120 receives the setting information packets transmitted by the receiving apparatus 200, acquires parameters for coding and compression of the picture signal PIC and the sound signal SND in accordance with the setting information, and output the parameters to the packet generation unit 110. Consequently, the packet generation unit 110 encodes the picture signal PIC and the sound signal SND, compresses the encoded data, and generates the picture packets and the sound packets in accordance with the parameters acquired by the setting information reception unit 120.

The receiving apparatus 200 of the present embodiment transmits the setting information packets at a predetermined cycle. Therefore, if the setting information reception unit 120 has not received a setting information packet for a certain interval from the reception of the last setting information packet, it can be judged that the channel 300 is congested resulting in transmission delay or that loss of information has occurred. In this case, the setting information reception unit 120 sends a command to the packet reception unit 110 to forbid transmission of packets. Accordingly, the amount of information transmitted through the channel 300 is lightened so as to enable recovery to the normal transmission state.

The network interface 130 modulates the picture packets and the sound packets generated by the packet generation unit 110 to a certain communication band according to a predetermined communication protocol, then transmits the modulated signals to the receiving apparatus 200 via the channel 300. In addition, the network interface 130 receives the information transmitted via the channel 300 and demodulates the received signals according to a predetermined communication protocol. Accordingly, the network interface 130 receives the signals transmitted by the receiving apparatus 200 through the channel 300, demodulates the received signals to generate the setting information packets, and outputs the same to the setting information reception unit 120.

Note that, in the transmitting apparatus 100 as described above, the network interface 130 is constituted by electronic circuits including a modulating circuit, a demodulating circuit, amplifiers, etc. However, the packet generation unit 110 and the setting information reception unit 120 can be constituted not only by hardware circuits, but also by software. That is, the packet generation unit 110 and the setting information reception unit 120 can be constituted by computer executable programs produced in accordance with processing for realizing the functions thereof, a storage medium for storing the programs, for example, a memory, and a processor like a CPU for executing the programs. When the transmitting apparatus 100 starts operation, for example, during initialization, the CPU performs processing so as to read the programs from the memory and execute them so as to analyze the setting information packets and acquire the desired parameters. Furthermore, the operations of sampling the picture signal PIC and the sound signal SND, generating the picture packets and the sound packets according to the setting information, then outputting the packets to the network interface 130 in sequence can be carried out automatically under the control of the CPU etc.

Below, the receiving apparatus 200 will be explained.

In the receiving apparatus 200, the packet reception unit 210 receives as input the packets received and reproduced by the network interface 230 and reproduces the picture signal and the sound signal accordingly. Further, the packet reception unit 210 is provided with a channel state judgment unit for judging the state of the channel that the packets passed through in accordance with the received packets.

The setting information generation unit 220 generates the setting information packets in accordance with, for example, the state of the channel acquired by the packet reception unit 210 as well as user operational commands input through the user interface 240, then outputs the generated packets to the channel 300 through the network interface 230. The setting information packets also include the parameters for designation of, for example, the frame rate, that is, the number of frames in a unit time, the size, and the quality (compression rate) of the picture signal and the sampling rate, the sound quality, etc. of the sound signal.

The network interface 230 receives the setting information packets generated by the setting information generation unit 220, generates transmission signals according to a predetermined communication protocol, and transmits the signals to the transmitting apparatus 100 through the channel 300. Furthermore, the network interface 230 receives the signals transmitted by the transmitting apparatus 100 from the channel 300, demodulates the received signals, generates the picture packets and sound packets, then outputs them to the packet reception unit 210.

The user interface 240 receives the operational commands from the user and outputs them to the setting information generation unit 220. The user interface 240 is constituted by, for example, a so-called pointing device, input pen, keyboard, etc. and enables a user to set or change parameters for designating the desired quality of the pictures and sound, the desired information amount, etc. to the receiving apparatus 200.

Note that in the receiving apparatus 200 described above, the components other than the network interface 230 and the user interface 240 are able to be constituted by software.

In the data communication system of the present invention described above, in the transmitting apparatus 100, the setting information reception unit 120 receives the setting information packets transmitted by the receiving apparatus 200, acquires the parameters to be utilized when generating the picture packets and the sound packets, and outputs them to the packet generation unit 110. The packet generation unit 110 generates the picture packets and the sound packets based on the picture signal and the sound signal to be transmitted to the receiving apparatus 200 in accordance with the parameters input from the setting information reception unit 120, then transmits them to the receiving apparatus 200 along the channel 300. In the receiving apparatus 200, the packet reception unit 210 receives the picture packets and the sound packets transmitted by the transmitting apparatus 100 and reproduces the picture signal and the sound signal. The setting information generation unit 220 sets the parameters to be utilized for generating the picture packets and the sound packets in accordance with the communication state of the channel 300 and the operational commands input by the user interface 240, generates the setting information packets in accordance with these parameters, and transmits them to the transmitting apparatus 100 through the channel 300.

In the data communication system of the present embodiment, by performing the control described above between the transmitting and receiving apparatuses, the information transmitted from the transmitting apparatus 100 to the receiving apparatus 200 can be suitably controlled according to the communication state of the channel 300. Particularly, in the receiving apparatus 200, the parameters utilized for generating the picture packets and the sound packets can be suitably set and transmitted to the transmitting apparatus so that the most necessary information can be received with the highest priority in accordance with the state of the channel 300. As a result, the transmitting apparatus 100 is able to transmit the desired information to the receiving side in accordance with the state of the channel 300 and the requests of the receiving side, therefore information that is able to be transmitted in accordance with the changes in traffic of the channel 300 or just information required by the receiving side can be transmitted to the receiving apparatus 200.

Below, the picture packets, the sound packets, and the setting information packets transmitted between the transmitting apparatus 100 and the receiving apparatus 200 in the data communication system according to the present embodiment will be explained.

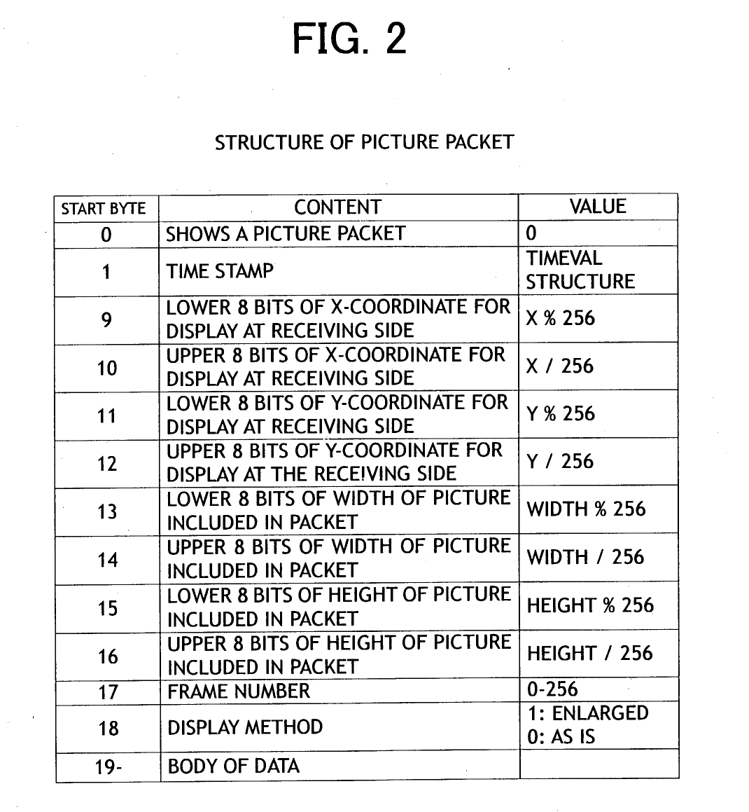

FIG. 2 is a view of the content of a picture packet. As illustrated, in the picture packet, the 0th to 18th bytes show the setting information, and the 19th byte on show the content of the picture data.

First, the 0th byte shows the type of the packet. Here, the value thereof is 0, which shows a picture. packet.

The 1st to 8th bytes show a time stamp of a Timeval structure and show the time when the picture packet is generated or the transmission time corrected by the transmitting apparatus 100.

The 9th to 12th bytes show the values of the X-coordinate and Y-coordinate for displaying a picture at the receiving side. Note that the X-coordinate and the Y-coordinate are divided into the lower 8 bits and higher 8 bits, respectively.

The 13th to 16th bytes show the width and the height of the picture included in the picture packet. Note that the width and the height of the picture are divided into the lower 8 bits and higher 8 bits, respectively.

The 17th byte shows the frame number. The frame number is, for example, the number assigned to each frame of a moving picture in sequence of time for display. In the transmitting apparatus 100, the frame number is assigned, for example, to each frame in time sequence. Consequently, by reproducing the picture signal according to the frame numbers of the received picture packets, the receiving apparatus 200 can reproduce a moving picture in the right sequence without being affected by variations in the channel delay time. Furthermore, loss of information can be detected based on the frame numbers of the received picture packets.

The 18th byte shows the method for displaying the picture. Here, for example, when the value thereof is 1, the picture should be displayed enlarged, while when the value is 0, the picture should be displayed in its original size.

The encoded picture data is stored from the 19th byte.

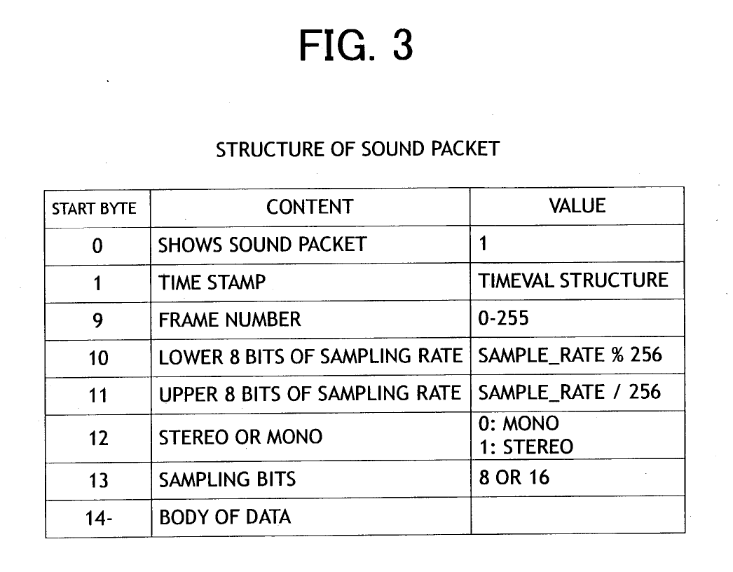

FIG. 3 is a view of the content of a sound packet. As illustrated, in the sound packet, the 0 to 13th bytes show the setting information, and the 14th byte on show the content of the sound data.

First, the 0th byte shows the type of the packet. Here, the value thereof is 1, which shows a sound packet.

The 1st to 8th bytes show a time stamp formed by a Timeval structure and show the time when the picture packet is generated or the transmission time corrected by the transmitting apparatus 100.

The 9th byte shows the frame number assigned according to the sequence in which the sound packet is generated. The frame number can be used, in the same way as that of the picture packet, to control the sequence for reproduction of the sound signal at the receiving side or to detect loss of information.

The 10th and 11th bytes show the sampling rate for digitalizing the sound signal. The sampling rate is shown by 16 bits of data, while the 10th and the 11th bytes show the lower 8 bits and the higher bits, respectively.

The 12th byte shows whether the sound signal is stereo or mono. Here, when the value is 0, mono is shown, while when the value is 1, stereo is shown.

The 13th byte shows the sample bits for digitizing the sound signal. The sample bits of the sound signal are, for example, 8 bits, 12 bits, or 16 bits. The larger the sample bits, the better the sound quality. The value of the byte shows the number of sample bits directly.

The 14th byte on show the content of the sound data.

The picture packets and the sound packets are both generated by the packet generation unit 110 in the transmitting apparatus 100 and transmitted to the receiving apparatus 200 through the channel 300. The packet reception unit 210 of the receiving apparatus 200 judges the type of the received packets. In the case of a picture packet, the reproduced picture is displayed according to the coordinates, size, and other information included in the picture packet, while in case of a sound packet, the sound signal is reproduced according to the sampling rate and other information included in the sound packet.

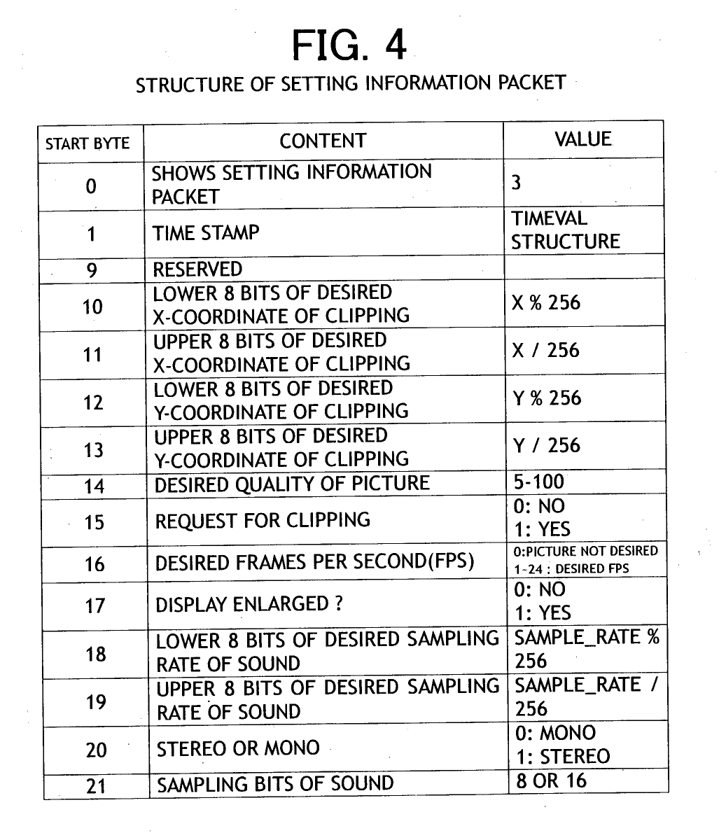

FIG. 4 is a view of the content of a setting information packet. The setting information packet is generated by the setting information generation unit 220 of the receiving apparatus 200 and transmitted to the transmitting apparatus 100 through the channel 300.

As illustrated in FIG. 4, a setting information packet is formed by 22 bytes.

First, the 0th byte shows the type of the packet. Here, the value thereof is 2, which shows a setting information packet.

The 1st to 8th bytes show a time stamp formed by a Timeval structure and show the time when the setting information packet is generated.

The 9th byte is a reserve byte.

The 10th to 13th bytes show the desired X-coordinate and Y-coordinate of a clipping area for displaying a picture when clipping is desired in displaying the picture in the receiving apparatus 200. Here, the X-coordinate and the Y-coordinate are divided into lower 8 bits and higher 8 bits, respectively.

The 14th byte shows the desired quality of the picture. This byte shows the quality of the picture by a numerical value, so the packet generation unit 110 of the transmitting apparatus 100 sets the parameters for encoding the picture signal that will influence the quality of the picture according to that numerical value. For example, when encoding a picture signal according to the JPEG standard, the quality and the amount of data of the encoded picture can be controlled by changing the compression rate according to the numerical value.

The 15th byte shows the need for clipping. When the value of the byte is 0, it shows that clipping is not required, while when the value of the byte is 1, it shows that clipping is required.

The 16th byte show the desired frame rate, that is, the number of frames per second. When the value of the byte is 0, it shows that picture information is not desired. That is, when the value of the byte is 0, the transmitting apparatus 100 does not transmit a picture packet to the receiving side.

The 17th byte shows whether the picture is to be displayed enlarged. When the value of the byte is 0, the picture will not be displayed enlarged, while when the value is 1, the picture will be displayed enlarged.

The 18th to 19th bytes show the desired sampling rate of the sound signal. The sampling rate of the sound signal is shown by 16 bits. The 18th and 19th bytes show the lower 8 bits and higher 8 bits, respectively.

The 20th byte shows whether the sound signal is stereo or mono. When the value of the byte is 0, it shows mono, while when the value is 1, it shows stereo.

The 21st byte shows the sampling size of the sound signal.

The setting information packet described above is generated by the setting information packet generation unit 220 in the receiving apparatus 200 and transmitted to the transmitting apparatus 100 through the channel 300. Consequently, the packet generation unit 110 of the transmitting apparatus 100 is able to encode the picture signal and the sound signal in accordance with the request of the receiving side, generate the picture packets and the sound packets, and transmit them to the receiving side.

In the data communication system of the present embodiment, the picture packets, the sound packets, and the setting information packets transmitted between the transmitting apparatus 100 and receiving apparatus 200 are able to be transmitted independently without regard as to the other packets. That is, complete information is included in each packet. At the receiving side, when a single packet is received, the sound information, picture information, or setting information can be reproduced without depending on other packets.

Accordingly, in the data communication system of the present invention, when loss of information occurs due to the state of the channel, that is, some of the packets among a plurality of the packets transmitted by the transmitting side cannot be transmitted to the receiving side, the receiving side is able to effectively reproduce the information of the packets which did arrive and utilize the information there. The state where information cannot be reproduced at all due to the loss of part of the information being transmitted can be avoided.

Below, the operation of the transmitting apparatus 100 and the receiving apparatus 200 will be explained by referring to flow charts.

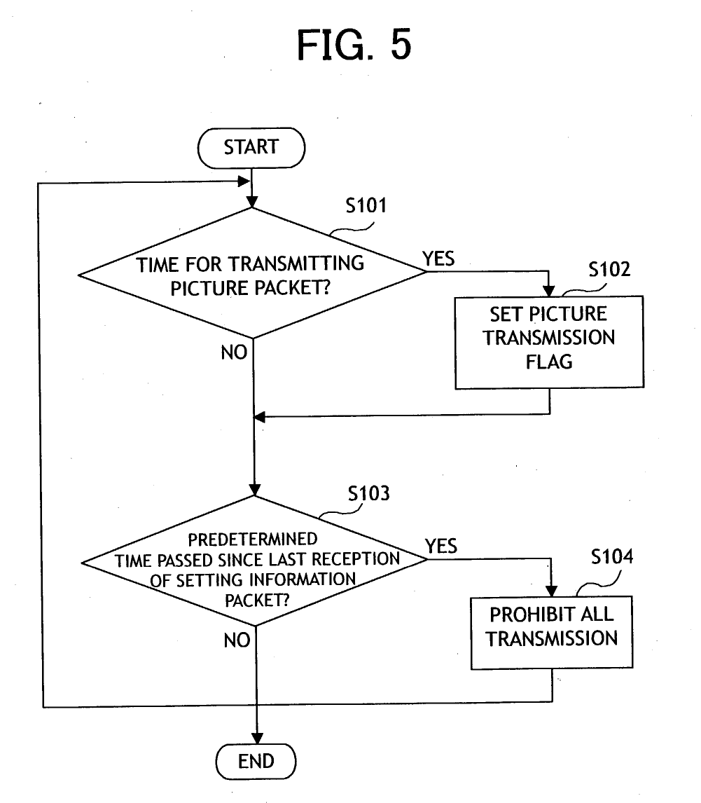

First, the operation of the transmitting apparatus 100 will be explained by referring to FIGS. 5 to 8. The operation shown in FIGS. 5 to 8 is carried out by the packet generation unit 110 and the setting information reception unit 120 of the transmitting apparatus 100. Note that when the transmitting apparatus 100 is constituted by a computer or a network server, the operation shown below is controlled by, for example, a CPU or other processor executing a program previously stored in a memory.

After initialization, the transmitting apparatus 100 performs time processing, picture processing, sound processing, and setting information reception processing. Note that although these processings are carried out in parallel, one processing will be carried out in accordance with the result of one of the other processings.

Initialization is carried out after the transmitting apparatus 100 is connected to the communication network or in response to an operational command for initialization. In the initialization, the transmitting apparatus 100 establishes the initial settings for communication with the receiving side. In the operation, for example, the communication protocol able to be used by the transmitting apparatus 100 is designated. Accordingly, the transmitting apparatus 100 becomes able to transmit packet data to a designated receiving apparatus.

In the data communication system of the present embodiment, for example, the user datagram protocol (UDP) capable of transmitting a large amount of data through a network at a high transmission rate is utilized as the communication protocol.

In addition, in the initialization, the initial setting information first used by the packet generation unit 110 of the transmitting apparatus 100 is set. The initial setting information is set by, for example, the initial values of the setting information stored in a predetermined storage medium of the transmitting apparatus 100 or the setting information used at the time when the preceding communication finished.

After initialization, time processing, picture processing, sound processing, and setting information reception processing are carried out in parallel.

First, the time processing will be explained referring to FIG. 5.

As illustrated in FIG. 5, in the time processing, first, it is judged whether the time for transmitting the picture packets has arrived (step S101). When the result of the judgment is that the time for transmitting the picture packets has arrived, the routine proceeds to step S102 where the picture packet transmission flag is set. Conversely, when the time for transmitting the picture packets has not arrived, the routine proceeds to step S103.

In the present embodiment, the transmitting apparatus 100 transmits the picture packets to the receiving apparatus 200 at a frame rate designated by the setting information packet. The transmitting apparatus 100 calculates the interval T_{PS} for transmitting the picture packets according to the frame rate included in the setting information packet. When the interval T_{PS} has passed, the transmitting apparatus 100 sets the picture packet transmission flag. In the picture processing, the timing for transmitting the picture packets is judged according to the picture packet transmission flag and then the picture packets are transmitted.

In step S103, it is judged whether a predetermined time has passed since the last reception of a setting information packet. In the data communication system of the present invention, the receiving apparatus 200 transmits setting information packets at predetermined transmission intervals. Accordingly, if the channel 300 is in a state where the data is transmitted normally, the setting information packets can be received by the transmitting apparatus 100 at a certain interval, for example, the transmission interval of the setting information packets at the receiving apparatus 200. However, when an abnormality occurs in the channel 300, for example, at the time of congestion and a long delay in data communication or loss of the transmitted packets, the transmitting apparatus 100 can no longer receive the setting information packets at the predetermined intervals. Accordingly, the time processing of the transmitting apparatus 100 can judge the reception intervals of the setting information packets and judge the state of the channel 300 in accordance with the results. When the transmitting apparatus 100 is not able to receive the setting information packets at the predetermined intervals, it judges that an abnormality has occurred in the channel 300, so prohibits all transmission of information (step S104) to lighten the traffic load of the channel 300 and restore it to the normal communication state.

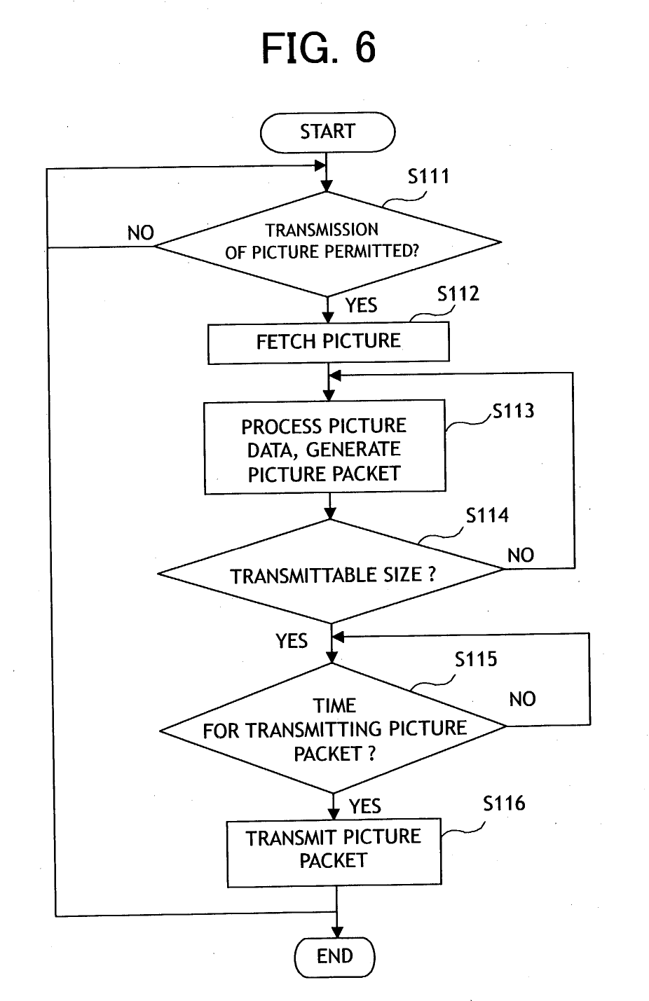

Below, the picture processing will be explained referring to FIG. 6.

As illustrated in FIG. 6, in the picture processing, first, it is judged whether picture transmission is permitted (step S111).

Here, it is judged whether picture transmission is permitted in accordance with the frame rate of the picture included in the setting information packet. In the setting information packet shown in FIG. 4, the frame rate, that is, the number of frames per second desired by the receiving side, is shown at the 16th byte. When the value of the byte is 0, it shows that the receiving side does not wish picture information. That is, when the value of the byte is 0, the transmitting apparatus 100 judges that the transmission of a picture is not permitted.

When it is judged at step S111 that transmission of a picture is not permitted, the routine stands by until the transmission of a picture is permitted. On the other hand, when it is judged that transmission of a picture is permitted, the routine proceeds to step S112 where the picture is fetched. The apparatus processes the fetched picture data to generate the picture packets (step S113).

Here, the processing of the picture data includes processing for dividing the picture suitably in accordance with the maximum packet size able to be transmitted, processing for encoding each part of the divided picture, etc. The picture data is divided out when there is a possibility that the packet size would exceed the maximum permissible size according to the protocol (for example, UDP) if the picture were encoded as is to generate the picture packets. In the present embodiment, the picture data processing is carried out by dividing the picture into a plurality of portions and using the picture data corresponding to each divided portion as a processing unit. Each of the divided portions is encoded to generate a picture packet.

As shown in FIG. 2, a picture packet includes the top left coordinates, the size (including the width and the height), the frame number, and other attribute information of the divided picture. Accordingly, when the receiving side receives any picture packet, it can decode the picture data and reproduce the original picture data in accordance with the attribute information included in the picture packet. In addition, it can display the picture data on a suitable display device based on the reproduced picture data, the coordinates of the picture, and other information.

In this way, in the present embodiment, when the receiving apparatus 200 receives any picture packet, it can reproduce the picture data by just the received picture packet. In this case, it does not require information of the other packets and can reproduce the picture data based on just the received packet. In the present embodiment, for example, if loss occurs in the packets transmitted to the receiving side due to the state of communication of the channel 300 etc., the original information can be reproduced correctly according to the received packets so the loss of information due to the loss of the packets can be kept to the minimum.

Next, it is judged if the size of the picture packet generated by the above processing is able to be transmitted (step S114). If the result of the judgment is that the generated packet is of a size able to be transmitted, the routine proceeds to step S115 where the transmission timing of the picture packet is judged. On the other hand, if the generated packet is of a size exceeding that able to be transmitted, the routine returns to step S113 where the picture is divided again to generate picture packets of a smaller size.

Further, when the result of the judgment is that the generated picture packet if of a size exceeding that able to be transmitted, it is also possible to discard the picture packet. In this case, for example, one frame or part of one frame will be lost among the consecutive frames of a moving picture, but this is not that much of a problem visually. By doing this, the transmitting apparatus 100 can, for example, lighten the processing load when processing a moving picture and can achieve faster processing.

Next, at step S115, it is judged whether the time for transmitting the picture packet has arrived. This is judged based on the picture packet transmission flag set at step S102 of the time processing described above. When the picture packet transmission flag is set, it is judged that the time for transmitting the picture packet has arrived and the picture packet is transmitted (step S116). On the other hand, when the picture packet transmission flag is not set, it is judged that the time for transmitting the picture packet has not arrived and the routine waits for the transmission time. Note that, after the transmission of the picture packet at step S116, the picture packet transmission flag is reset. Accordingly, when the next transmission time of a picture packet arrives, the picture packet transmission flag will be set again by the time processing.

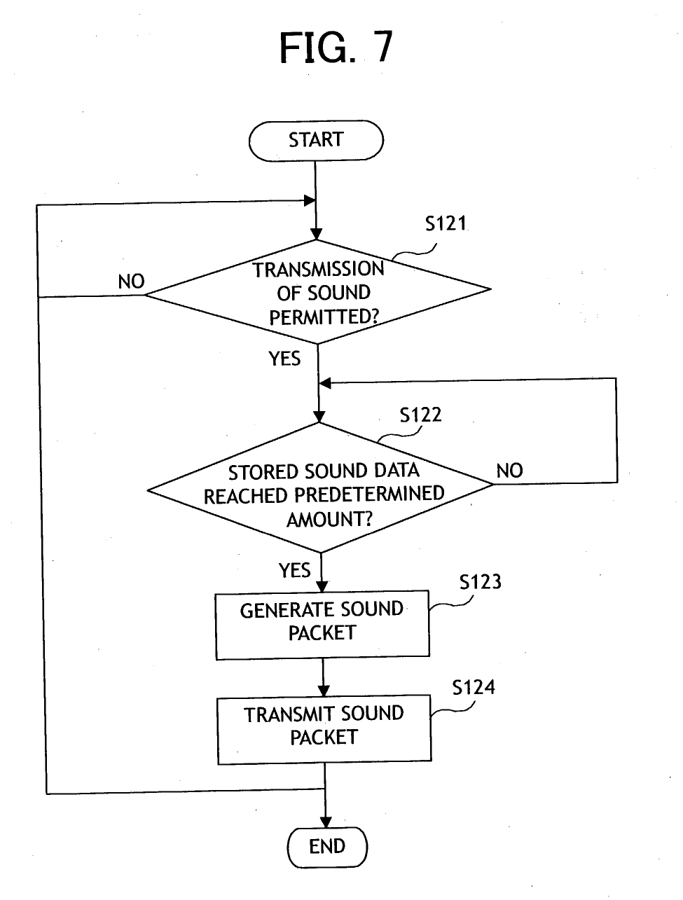

Below, the sound processing will be explained referring to FIG. 7.

As illustrated in FIG. 7, in the sound processing, first, it is judged whether sound transmission is permitted (step S121). Here, whether the sound transmission is permitted is judged based on the sound sampling rate included in the received setting information packet. In the setting information packet shown in FIG. 4, the sound sampling rate desired by the receiving side is shown in the 18th and 19th bytes. When the values of these bytes are 0, it shows that the receiving side does not desire sound information. That is, when the values of these bytes are 0, the transmitting apparatus 100 judges that the transmission of the sound packets is not permitted.

When it is judged at step S121 that the transmission of the sound packets is not permitted, the routine stands by until transmission of the sound packets stands is permitted. On the other hand, it is judged that transmission of the sound is permitted, the routine proceeds to step S112.

At step S112, it is judged whether the amount of the stored sound data has reached a predetermined volume or not. The sound signal is sampled at the sampling rate included in-the setting information. The sampled sound data is stored temporarily in a buffer memory.

In step S122, it is judged whether the stored sound data has reached a predetermined amount. When the predetermined amount has not been reached, the sound data continues to be stored until the predetermined amount is reached. When the predetermined amount is reached, a sound packet is generated (step S123), and the generated sound packet is transmitted (step S124).

In the sound processing, the processing of steps S121 to S124 is repeatedly carried out.

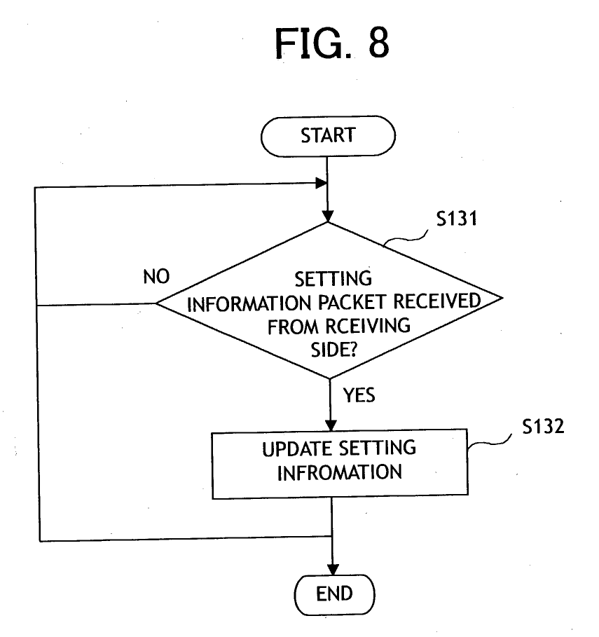

Next, the setting information reception processing will be explained referring to FIG. 8.

As illustrated in FIG. 8, in the setting information reception processing, first it is judged whether a setting information packet is received from the receiving side (step S131). If the result of the judgment is that no setting information packet has been received, the routine stands by until a setting information packet is received. On the other hand, if it is judged that a setting information packet has been received, the routine proceeds to step S132.

At step S132, the setting information is read out from the received setting information packet, and the setting information is updated accordingly.

The transmitting apparatus 100 of the present embodiment performs the time processing, the picture processing, the sound processing, and the setting information reception processing in parallel. Therefore, the transmitting apparatus 100 constantly updates the setting information based on the setting information packets received from the receiving apparatus 200, generates the picture packets and sound packets in accordance with the updated setting information, and transmits the picture packets and the sound packets to the receiving apparatus 200 through the channel 300 in accordance with the desires of the receiving side. Accordingly, in the present embodiment, the setting information is set and updated by the receiving side in accordance with the state of the channel 300, and the setting information packets are generated in accordance with the setting information, then transmitted to the transmitting apparatus 100 through the channel 300. In the transmitting apparatus 100, since the setting information is updated according to the received setting information packets and the transmission of the packets is controlled accordingly, transmission of information in accordance with the desires of the receiving side can be achieved.

Below, the processing in the receiving apparatus 200 will be explained.

The data communication system of the present embodiment performs time processing, reception processing, and event processing in the receiving apparatus 200.

The receiving apparatus 200 is initialized when the power is turned on, the network is connected to the first time, or a reset command is received from the outside. In the initialization, for example, a window for displaying the received picture signal is opened at the display device. Then, the initial values of the parameters for packet reception and the reproduction of the picture and sound signals are set. After the initialization, the time processing, the reception processing, and the event processing start.

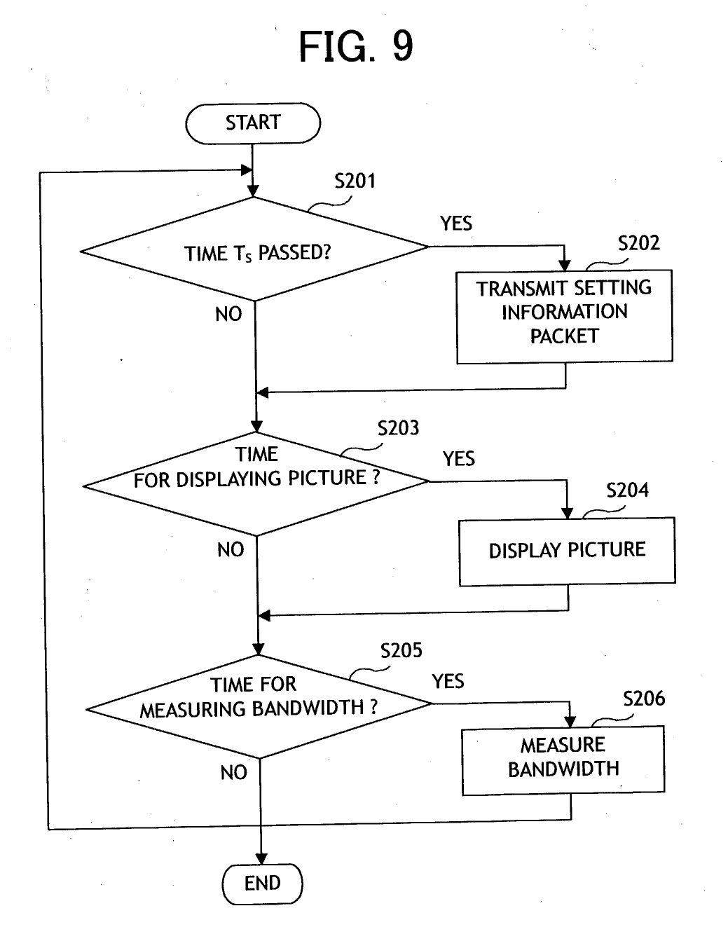

FIGS. 9 to 13 are flow charts of the operation of the receiving apparatus 200. Below, the operation of the receiving apparatus 200 will be explained while referring to these flow charts.

FIG. 9 is a flow chart of the time processing of the receiving apparatus 200. In the time processing, first it is judged whether the time T_{S} has passed (step S201). When the result of the judgment is that the time T_{S} has passed, the routine proceeds to step S202, where control information is transmitted. On the other hand, if the result of the judgment at step S201 is that the time T_{S} has not passed, the routine proceeds to step S203.

Note that the time T_{S} at step S201 is a predetermined interval for transmission of the setting information packets set previously, that is, the period for transmitting the setting information packets from the receiving apparatus 200 to the transmitting apparatus 100. The time T_{S} is, for example, one second.

At step S203, it is judged whether the display time of the picture has arrived or not. This is judged in accordance with the frame rate included in the setting information. That is, the interval T_{P} between the frames is calculated according to the desired frame rate of the picture. At step 203 of the time processing, it is judged whether the interval T_{P} has passed since the last time for display of a picture so as to judge the time for displaying the picture.

When the time for displaying a picture has arrived, the picture is displayed (step S204). In the picture display, the picture data is read from a picture data buffer, described later, and a picture is displayed on the display device based on the coordinates corresponding to that picture data and the size of the picture. On the other hand, when the time for displaying a picture has not arrived, the routine proceeds to step S205.

At step S205, it is judged whether the time for bandwidth measurement has arrived. If the result of the judgment is that the time for measurement has arrived, the routine proceeds to step S206, where the bandwidth is measured. On the other hand, if it is judged that the time for measurement has not arrived, the routine returns to step S201.

Below, the bandwidth measurement at step S206 will be explained.

The receiving apparatus 200 of the present embodiment measures the bandwidth at a predetermined interval. Here, the “bandwidth” indicates the amount of information transmitted through the channel 300 per unit time. In the present embodiment, the transmission time of a packet is measured approximately in accordance with the time stamp of the packet, and the bandwidth is calculated in accordance with the measured transmission time and the size of the packet. Below, the measurement of the bandwidth will be explained concretely.

First, the transmitting apparatus 100 acquires the transmission time of the setting information packet from the time stamp included in the setting information packet received from the receiving apparatus 200, then obtains the time difference between the transmission time and the local time of the transmitting apparatus 100.

Next, the transmitting apparatus 100 adds the calculated time difference to the time stamps of all packets to be transmitted before transmission.

The receiving apparatus 200 calculates the time difference between the time acquired according to the time stamp of each received packet and the local time and uses the time difference as the transmission time of the packet. Further, it stores the size of the received packet and the calculated transmission time of the packet.

The bandwidth BW of the channel 300 is calculated using the information of the transmission times of two packets of different sizes according to following equation.

BW=(S1−S2)/(T1−T2) (1)

Here, in equation 1, BW shows the bandwidth in units of bits/second, S1 and S2 show the packet size of the two packets, T1 shows the minimum transmission time of a packet of size S1, and T2 shows the minimum transmission time of a packet of size S2. Note that in equation 1, S1>S2 and T1>T2. Here, the “minimum transmission time” is the transmission time of the packet arriving at the receiving side earliest among packets of the same size.

At step S206 of the time processing of the receiving apparatus 200, the bandwidth of the channel 300 can be calculated approximately by the processing described above. Since the calculated bandwidth BW is shown at the display of the receiving apparatus 200, the user of the receiving apparatus 200 is able to judge the state of the channel 300 according to the bandwidth BW displayed, change the setting information accordingly, and request the desired information from the transmitting apparatus 100 in accordance with the state of the channel 300.

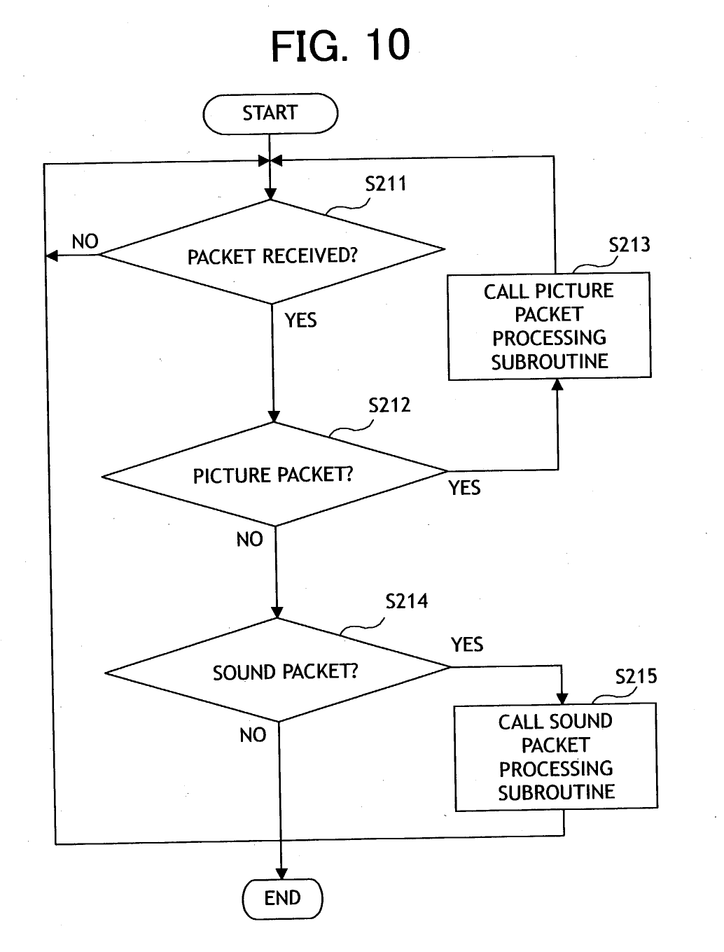

Next, the reception processing of the receiving apparatus 200 will be explained referring to FIG. 10.

As illustrated in FIG. 10, in the reception processing, first it is judged whether a packet is received (step 5211). If the result of the judgment is that a packet is not received, the routine stands by until a packet is received. On the other hand, if the result of the judgment is that a packet is received, the routine proceeds to step S212.

At step S212, it is judged whether the received packet is a picture packet. If the result of the judgment is that the received packet is a picture packet, the routine proceeds to step S123, where a subroutine for processing a picture packet is called. On the other hand, if the result of the judgment is that the received packet is not a picture packet, the routine proceeds to step S214. The subroutine of the picture packet processing will be described in detail later.

At step S214, it is judged whether the received packet is a sound packet. If the result of the judgment is that the received packet is a sound packet, a subroutine for processing a sound packet is called (step S215). When the processing of the subroutine of the sound packet processing is ended, the routine returns to step S211. On the other hand, if the result of the judgment at step S214 is that the received packet is not a sound packet, the routine returns to step S211.

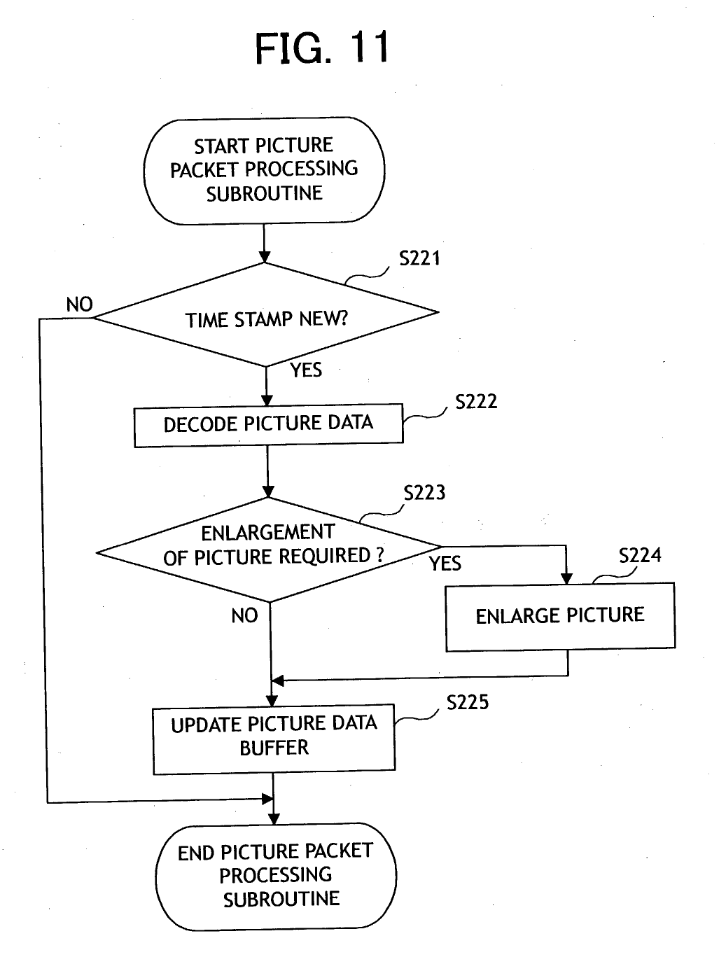

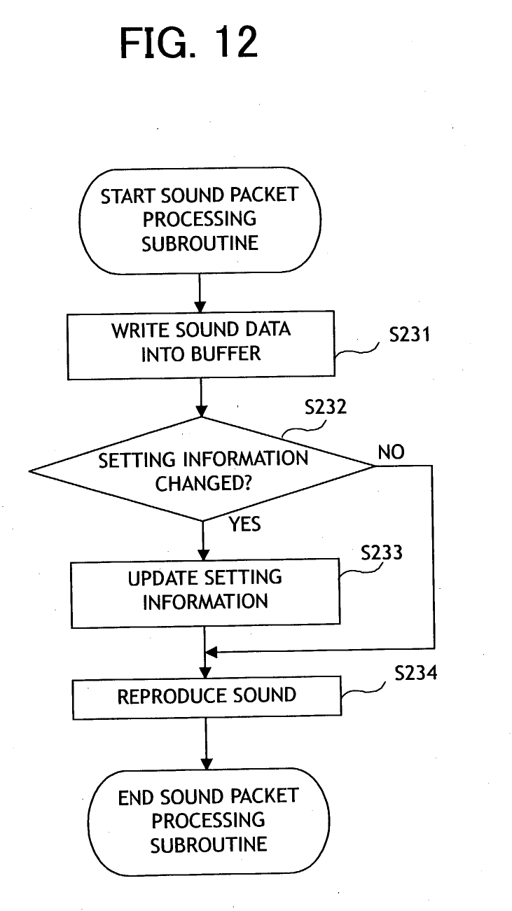

Below, the subroutines of the picture packet processing and the sound packet processing will be described referring to FIGS. 11 and 12.

FIG. 11 is a flow chart of the subroutine of the picture packet processing.

As illustrated, in the subroutine of the picture packet processing, first it is judged whether the time stamp included in the picture packet is new (step S221). Here, this is judged by comparison of the time stamp included in the received picture packet with the time stamp of the picture packet received previously.

If the result of the judgment at step S221 is that the time stamp is not new, the subroutine of the picture packet processing ends. On the other hand, if the time stamp is new, the picture data included in the received picture packet is decoded (step S222).

Next, it is judged whether enlargement is required based on the received picture packet (step S223). This is judged based on the value of the 18th byte included in the picture packet, which shows the method for picture display. If the result of the judgment is that enlargement is required, the routine proceeds to step S224, while if the result is that enlargement is not required, the routine proceeds to step S225.

At step S224, the decoded picture is enlarged, then the routine proceeds to step S225.

At step S225, the picture data buffer is updated by the processed picture data. Note that along with the updating of the picture data, the display coordinates, the picture size, and other information corresponding to the picture data are also updated.

According to the subroutine of the picture packet processing, when a new picture packet is received, the content of the picture data buffer is updated according to the picture packet. In the time processing described above, when the judgment is that the time for displaying the picture has arrived, the picture displayed on the display of the receiving apparatus 200 is updated.

FIG. 12 is a flow chart of the subroutine of the sound packet processing.

As illustrated, in the subroutine of the sound processing, first, the sound data included in the sound packet is written into a sound data buffer (step S231).

Next, it is judged whether the setting information has changed based on to the setting information included in the sound packet (step S232). If the result of the judgment is that the setting information has changed, the routine proceeds to step S233, while if the judgment is that the setting information has not changed, the routine proceeds to step S234.

At step S233, the setting information is updated based on the sound packet, then the routine proceeds to step S234. At step S234, the sound is reproduced according to the sound data stored in the sound data buffer.

According to the subroutines of the picture packet processing and the sound packet processing described above, the setting information is updated based on the packets, then the picture and the sound signals are reproduced according to the updated setting information.

Below, the event processing of the receiving apparatus 200 will be explained. Here, an event means an operation performed by a user by the user interface, for example, a keyboard or a mouse. For example, when the user inputs data with a keyboard or clicks on the screen using a mouse etc., that is, a so-called pointing device, an event occurs. The receiving apparatus 200 detects the occurrence of the event and updates the setting information by the receipt of the event.

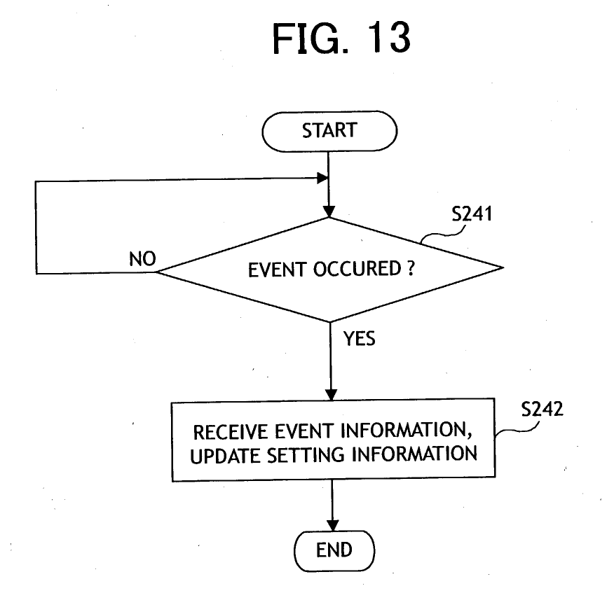

FIG. 13 is a flow chart of event processing. As illustrated in FIG. 13, in the event processing, first it is judged whether an event has occurred (step S241). If the result of the judgment is that an event has occurred, the routine proceeds to step S242. On the other hand, if the judgment is that no event has occurred, the routine stands by until an event occurs.

At step S242, the occurring event is received and the setting information is updated in accordance with the content of the event.

According to the event processing described above, the receiving apparatus 200 of the present embodiment can receive an operational command of the user and update the setting information in accordance with the content of the command. Accordingly, it can request information desired by the user from the transmitting apparatus 100 and can receive the information most desired by the user in accordance with the state of the channel 300.

Below, the picture displayed on the display in the receiving apparatus 200 of the present embodiment will be explained.

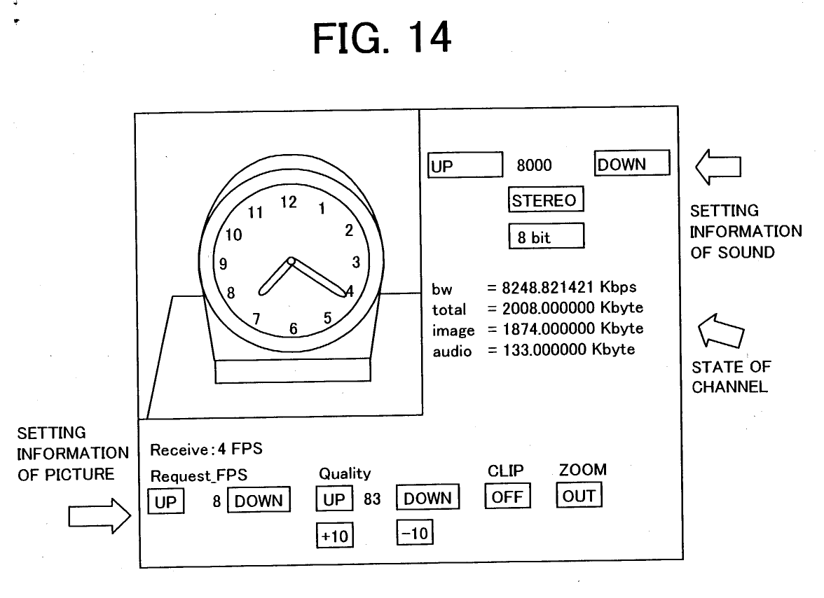

FIG. 14 shows an example of a picture displayed on the display of the receiving apparatus 200. As illustrated, the picture reproduced according to a picture packet transmitted by the transmitting apparatus 100 is displayed. Besides the picture information, the setting information and the state of the channel 300, for example, the bandwidth, are displayed, too.

In addition, as illustrated, besides the information about the picture, the setting information, and the state of the channel, operational commands for changing the setting information are displayed too. For example, operation buttons for changing the frame rate (FPS) of the picture, a coefficient showing the quality of the picture, the sampling rate of the sound signal, and other parameters are also displayed. As a result, if the user clicks an operation button using a mouse etc., an event occurs. Therefore, the receiving apparatus 200 receives the occurring event by the event processing, performs the designated operations, and changes the parameters of the desired setting information. Further, besides these operational commands, the user is able to directly input the parameters by the keyboard.

As described above, according to the data communication system of the present embodiment, the receiving apparatus 200 reproduces the picture and the sound signals based on the received picture packets and the sound packets. Further, along with the reproduced picture, it displays the setting information, the state of the channel, and the operational commands about the setting information on the display of the receiving apparatus 200. The receiving apparatus 200 receives the operational commands by the user as events, changes the setting information accordingly, and transmits the updated setting information to the transmitting apparatus 100. According to this, the transmitting apparatus 100 samples the picture and sound signals using predetermined parameters according to the setting information from the receiving apparatus 200, generates the picture and the sound packets, and transmits them to the receiving apparatus 200. Therefore, it is possible to transmit information desired by the user from the transmitting apparatus 100 to the receiving apparatus 200 in accordance with the state of the channel 300.

Summarizing the effects of the invention, as described above, according to the receiving apparatus, the data communication system, and the data communication method for the present invention, it is possible to transmit the exactly desired information to the receiving side through a channel in accordance with the setting information transmitted from the receiving side, so it is possible to supply the information most desired by the receiving side in accordance with the state of the channel. Accordingly, in the present invention, there is the advantage that the receiving side is able to actively control the transmitted information in accordance with the state of the channel, so it is possible to flexibly deal with changes in the communication environment and to provide user-friendly, convenient user interface.

While the invention has been described with reference to specific embodiments chosen for purpose of illustration, it should be apparent that numerous modifications could be made thereto by those skilled in the art without departing from the basic concept and scope of the invention.

What is claimed is:

1. A receiving apparatus comprising:
a reception unit for receiving content data transmitted through a communication network;
a signal reproduction unit for generating at least one of a picture signal and sound signal in accordance with the content data received by the reception unit;
a channel state judgment unit for judging the state of the channel through which the content data is transmitted in accordance with the received content data; and
a setting information generation unit for generating setting information and transmitting it to a transmitting apparatus, wherein the setting information includes parameters for generating the content data in accordance with the result of the judgment by the channel state judgment unit and commands input from outside based on the result of the judgment.

2. A receiving apparatus according to claim 1, further comprising a user interface by which user's operational commands are input,
the setting information generation unit generating the setting information based on input information from the user interface.

3. A receiving apparatus according to claim 2, wherein the user interface has a display unit that displays the setting information generated by the setting information generation unit.

4. A receiving apparatus according to claim 3, wherein the display unit displays the state of the channel judged by the channel state judgment unit.

5. A receiving apparatus according to claim 1, wherein the channel state judgment unit measures a bandwidth of the channel.

6. A receiving apparatus according to claim 4, wherein:
the user interface inputs a command for changing the setting information according to a user's operational command based on the setting information and the state of the channel displayed on the display unit; and
the setting information generation unit changes the setting information according to the command for change input by the user interface.

7. A receiving apparatus according to claim 1, wherein the setting information generation unit judges a state of loss of the received content data and changes the setting information according to the result of the judgment.

8. A data communication system for transmitting at least one of picture data and sound data through a communication network, comprising:
a transmitting apparatus including:
a data generation unit for encoding at least one of a picture signal and sound signal and generating at least one of picture data and sound data in accordance with setting information and
a setting information reception unit for receiving setting information transmitted from a receiving apparatus through the communication network and providing the setting information to the data generation unit and
a receiving apparatus including:
a reception unit for receiving at least one of the picture data and the sound data transmitted from the transmitting apparatus through the communication network and
a setting information generation unit for judging the transmitting state of the communication network in accordance with the received data by the reception unit, generating the setting information including parameters for generating at least one of the picture data and the sound data in the data generation unit of the transmitting apparatus according to the judgment result, and transmitting the setting information to the transmitting apparatus through the communication network.

9. A data communication system according to claim 8, wherein the data generation unit encodes at least one of the picture signal and sound signal by using a predetermined encoding method and generates at least one of picture data and sound data according to parameters included in the setting information.

10. A data communication system according to claim 8, wherein the data generation unit divides the picture signal into portions of a predetermined size, encodes each divided portion using a predetermined encoding method, and generates picture packets in accordance with the encoded picture data and the predetermined setting information.

11. A data communication system according to claim 8, wherein the setting information generation unit transmits the setting information to the transmitting apparatus at predetermined intervals.

12. A data communication system according to claim 11, wherein the setting information reception unit stops the transmission of the picture data and the sound data when the setting information has not been received for a predetermined time.

13. A data communication method for transmitting picture data and sound data through a communication network, comprising:
having a transmitting apparatus receive setting information transmitted from a receiving apparatus through the communication network and
encode at least one of a picture signal and sound signal in accordance with the setting information and generate at least one of picture data and sound data and
having a receiving apparatus receive at least one of the picture data and sound data transmitted from the transmitting apparatus and
judge the transmission state of the communication network in accordance with the received data, generate setting information including parameters for generating at least one of the picture data and sound data in the transmitting apparatus according to the judgment result, and transmit the setting information to the transmitting apparatus through the communication network.

14. A data communication method according to claim 13, further comprising having the receiving apparatus receive a user's operational command and generate or change the setting information according to the input operational command.

15. A data communication method according to claim 13, further comprising:
having the receiving apparatus transmit the setting information to the transmitting apparatus through the communication network at predetermined intervals and
having the transmitting receiving apparatus stop transmitting the picture data and the sound data when the setting information has not been received for a predetermined time.
